(19) United States
(12) Patent Application Publication
(10) Pub. No.: US 2024/0010461 A1
(43) Pub. Date: Jan. 11, 2024

(54) ELEVATOR CONTROL

(71) Applicant: Kone Corporation, Helsinki (FI)

(72) Inventors: Markku HAAPANIEMI, Helsinki (FI); Matti RASANEN, Helsinki (FI)

(73) Assignee: Kone Corporation, Helsinki (FI)

(21) Appl. No.: 18/472,712

(22) Filed: Sep. 22, 2023

Related U.S. Application Data
(63) Continuation of application No. PCT/FI2021/050265, filed on Apr. 14, 2021.

(51) Int. Cl. B66B 1/24; B66B 19/00; B66B 1/28

(52) U.S. Cl. CPC B66B 1/2408; B66B 19/00; B66B 1/28; B66B 2201/24; B66B 2201/4653; B66B 2201/4615; B66B 2201/4676

(57) ABSTRACT

According to an example embodiment, an elevator control system is provided, the elevator control system comprising an elevator controller for controlling movement of one or more elevators of an elevator transport system between one or more floors of a building under construction; and a scheduling system for maintaining a transport reservation schedule pertaining to said one or more elevators, wherein the transport reservation schedule comprises one or more transport reservations that comprise at least a first transport reservation that defines at least a first reserved transport time period, a first origin floor, and a first activation code, wherein the elevator controller is arranged to: control an elevator allocated to serve the first transport reservation to arrive at the first origin floor by the beginning of the first transport time period, and control, during the first reserved transport time period, said elevator allocated to serve the first transport reservation to move to a destination floor in response to receiving an activation code that matches the first activation code.

### CROSS-REFERENCE TO RELATED APPLICATION

This application is a continuation of PCT International Application No. PCT/FI2021/080265 which has an International filing date of Apr. 14, 2021, the entire contents of which are incorporated herein by reference.

### TECHNICAL FIELD

The example and non-limiting embodiments of the present invention relate to elevator control and, in particular, controlling operation of and access to an elevator during construction of a building.

### BACKGROUND

When construction a multi-storey building, transportation of construction workers and construction materials to upper floors in an efficient manner requires usage of one or more elevators. Such elevators may comprise ‘traditional’ construction elevators provided on the exterior of the building under construction and/or elevators that will be provided as or will be later on converted into the elevators of the finalized building.

Especially with high-rise buildings having tens of floors fluent transportation of construction workers and especially fluent transportation of construction materials is an important factor in efficiency of the construction project and, consequently, it may have a significant effect on a schedule of construction project. In particular, poorly managed usage of elevator capacity applied in the construction site risks inefficient flow of constructions materials and construction workers between the floors of the building, which may cause unnecessary delay and, consequently, introduce additional costs to the construction project.

### SUMMARY

It is an object of the present invention to provide a technique that facilitates expedient usage of elevator transport capacity available in a building that is under construction.

According to an example embodiment, an elevator control system is provided, the elevator control system comprising an elevator controller for controlling movement of one or more elevators of an elevator transport system between one or more floors of a building under construction; and a scheduling system for maintaining a transport reservation schedule pertaining to said one or more elevators, wherein the transport reservation schedule comprises one or more transport reservations that comprise at least a first transport reservation that defines at least a first reserved transport time period, a first origin floor, and a first activation code, wherein the elevator controller is arranged to: control an elevator allocated to serve the first transport reservation to arrive at the first origin floor by the beginning of the first transport time period, and control, during the first reserved transport time period, said elevator allocated to serve the first transport reservation to move to a destination floor in response to receiving an activation code that matches the first activation code.

According to another example embodiment, an elevator system comprising an elevator transport system comprising one or more elevators and an elevator control system according to the example embodiment described in the foregoing is provided.

According to another example embodiment, a method for controlling movement of one or more elevators of an elevator transport system between one or more floors of a building under construction is provided, the method comprising: maintaining a transport reservation schedule pertaining to said one or more elevators, wherein the transport reservation schedule comprises one or more transport reservations that comprise at least a first transport request that defines at least a first reserved transport time period, a first origin floor, and a first activation code; controlling an elevator allocated to serve the first transport reservation to arrive at the first origin floor by the beginning of the first transport time period; and controlling, during the first reserved transport time period, said elevator allocated to serve the first transport reservation to move to a destination floor in response to receiving an activation code that matches the first activation code.

According to another example embodiment, a computer program is provided, the computer program comprising computer readable program code configured to cause performing at least the method according to the example embodiment described in the foregoing when said program code is executed on one or more computing apparatuses.

The computer program according to the above-described example embodiment may be embodied on a volatile or a non-volatile computer-readable record medium, for example as a computer program product comprising at least one computer readable non-transitory medium having the program code stored thereon, which, when executed by one or more computing apparatuses, causes the computing apparatuses at least to perform the method according to the example embodiment described in the foregoing.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1 illustrates a block diagram of some logical elements of an elevator system according to an example;

FIG. 2 illustrates a method according to an example, and

FIG. 3 illustrates a block diagram of some components of an apparatus according to an example.

### DESCRIPTION OF SOME EMBODIMENTS

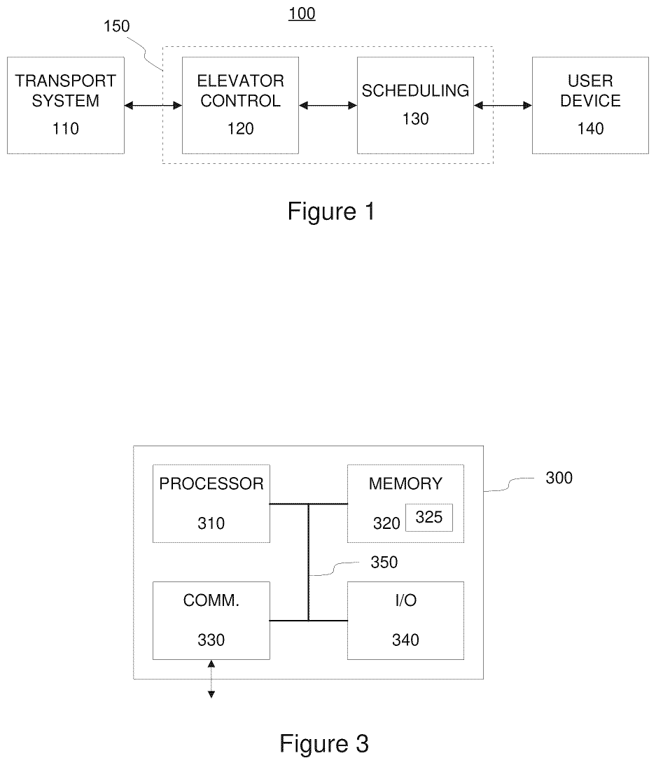

FIG. 1 illustrates a block diagram of some logical elements of an elevator system 100 according to an example. The elevator system 100 is shown in the example FIG. 1 with an elevator transport system 110 comprising one or more elevators for transporting passengers and/or cargo, an elevator controller 120 for controlling movement of the one or more elevators between one or more floors of a building, and a scheduling system 130 for maintaining transport reservation schedule pertaining to the elevator transport system 110. In particular, the elevator system 100 may be applicable in a building under construction to enable transportation of passengers and cargo between the floors of the building under construction. Such an elevator system 100 may be referred to as a construction-time elevator system. As an example in this regard, the construction-time elevator system may comprise one or more elevator components that need to be installed or replaced with other ones in order to render the construction-time elevator system into one that serves all regulatory and functional requirements of an elevator system suitable for normal passenger use and/or the elevator transport system 110 of the construction-time elevator system may comprise one or more vertically-extendable elevators that are extendable to serve an increasing number of floors as the number of floors in the building under construction increases with the progress of the construction work.

The elevator system 100 may further comprise or it may be communicatively coupled to a user interface device 140 that enables placing transport reservations for transportation using the elevator transport system 110 at a later time and/or placing transport requests for immediate transportation using the elevator transport system 110. For graphical clarity of illustration, the example depicted in FIG. 1 shows only a single user interface device 140. However, the elevator system 100 may comprise or it may be communicatively coupled to one or more user interface devices, whereas the user interface device 140 shown in FIG. 1 serves to represent the one or more user interface devices.

Along the lines described in the foregoing, the elevator transport system 110 comprises one or more elevators installed in a building that is currently under construction to enable transportation of passengers and cargo between floors of the building under construction. In this regard, the one or more elevators may comprise, for example, one or more ‘traditional’ construction elevators provided on the exterior of the building under construction and/or one or more elevators inside the building under construction, which elevators will be subsequently applied as or converted into elevators for transporting occupants (e.g. residents or visitors) of a completed building. Regardless of details of the types of the one or more elevators under consideration, without losing generality, each of the one or more elevators of the elevator transport system 110 may be considered as one arranged to serve for transporting passengers and/or cargo between two or more floors or levels, where in each floor/level the area or location for entering or exiting the elevator car(s) may be referred to as a respective landing or landing area of the elevator transport system 110.

The elevator transport system 110 is operated under control of the elevator controller 120 that is arranged for controlling movement of the one or more elevators of the elevator transport system 110. In this regard, the elevator controller 120 may be communicatively coupled to elevator transport system 110 via a wired or wireless communication network or communication link. The elevator controller 120 may comprise or may be provided using one or more computer apparatuses, where each computer apparatus comprises respective one or more processors arranged to execute a respective computer program stored in one or more memories therein, the execution of the computer programs thereby causing the one or more computer apparatuses to provide at least some aspects of operation of the elevator controller 120. Hence, the elevator controller 120 may be provided as an elevator controller apparatus (e.g. using a single computer apparatus) or as an elevator controller system (e.g. using two or more computer apparatuses). At least some aspects of operation of the elevator controller 120 described via examples provided in the following may arise from execution of the above-described respective computer programs in the respective computer apparatuses.

In context of the present disclosure, an aspect of interest in relation to the elevator transport system 110 is management of transport requests pertaining to the one or more elevators of the elevator transport system 110 and, consequently, any aspects related to the structure and operation of the one or more elevators of the elevator transport system 110 and/or those of the elevator controller 120 for controlling movement of the one or more elevators may be provided using techniques known in the art and. Therefore, any details concerning their structure and operation are described herein only to extent they are necessary for describing examples that pertain to management and implementation of transport requests pertaining to the one or more elevators of the elevator transport system 110.

The scheduling system 130 may comprise or it may be provided using a computer apparatus comprising one or more processors arranged to execute a computer program stored in one or more memories therein, the execution of the computer program thereby causing the computer apparatus to provide at least some aspects of operation of the scheduling system 130. In particular, at least some aspects of operation of the scheduling system 130 described via examples provided in the following may arise from execution of the above-described computer program in said computer apparatus. In this regard, the scheduling system 130 may be provided as part of the elevator controller 120 or the scheduling system 130 may be an element that is separate from the elevator controller 120 but that is communicatively coupled thereto via a wired or wireless communication network or communication link. Regardless of their arrangement with respect to each other, the elevator controller 120 and the scheduling system 130 may be considered as elements of an elevator control system 150.

The scheduling system 130 stores the transport reservation schedule that comprises one or more transport reservations pertaining to the one or more elevators of the elevator transport system 110. As an example in this regard, each transport reservation recorded in the transport reservation schedule includes, defines or has otherwise associated therewith at least the following pieces of information:
an origin floor,
a reserved transport time period,
an indication of the elevator allocated to serve the respective transport reservation.

In this regard, in case the elevator transport system 110 includes only a single elevator, the indication of the elevator allocated to serve the respective transport reservation may be redundant and this piece of information may be omitted from the transport reservation. The transport reservation may further include one or more of the following pieces of information:
a destination floor,
an owner of the transport reservation,
an activation code for the transport reservation,
a release code for the transport reservation.

The pieces of information that may be included in the transport reservation are described in more detail via examples provided in the following.

In the course of operation of the elevator transport system 100 the elevator controller 120 may receive transport requests for immediate elevator transport using one of the one or more elevators of the elevator transport system 110. Such transport requests may be referred to as direct transport requests (as opposed to indirect transport requests recorded as respective transport reservations in the transport reservation schedule stored in the scheduling system 130) and they may originate, for example, from call giving devices arranged in landings of the one or more elevators. Upon receipt of such a direct transport request pertaining to a certain elevator (of the one or more elevators of the elevator transport system 110), the elevator controller 120 may consult the scheduling system 130 to determine whether there is a transport reservation covering the current time. Consequently, in case the transport reservation schedule does not include a transport reservation for the certain elevator that covers the current time, the elevator controller 120 may serve the direct transport request in accordance with normal scheduling of direct transport requests, whereas in case the transport reservation schedule includes a transport reservation for the certain elevator that covers the current time, the elevator controller 120 may refuse or ignore the direct transport request. Hence, the transport reservations recorded in the transport reservation schedule have a preference over direct transport requests received during the respective reserved transport time periods.

The user interface device 140 may comprise or it may be provided as a computer apparatus comprising one or more processors arranged to execute a computer program stored in one or more memories therein, the execution of the computer program thereby causing the computer apparatus to provide at least some aspects of operation of the user interface device 140. In particular, at least some aspects of operation of the user interface device 140 described via examples provided in the following may arise from execution of the above-described computer program in said computer apparatus. The user interface device 140 may be communicatively coupled to the scheduling system 130 or it may be able to establish a communicative coupling to the scheduling system 130. Moreover, the user interface device 140 may be communicatively coupled to the elevator controller 120 or it may be able to establish a communicative coupling to the elevator controller 120. The communicative couplings in this regard may be provided, for example, via a wired or wireless communication network or communication link.

The user interface device 140 may comprise a user interface (UI) for receiving input from a user and for displaying information to the user. In particular, the UI may be arranged to receive user input pertaining to transport reservations to be recorded in the transport reservation schedule at the scheduling system 130 and possibly also to display information pertaining to transport reservations currently recorded in the transport reservation schedule at the scheduling system 130. In other words, the user interface device 140 may provide a user with access to the transport reservation schedule stored in the scheduling system 130 in terms of placing a new transport reservation request and/or reviewing transport reservations entered in the transport reservation schedule earlier. A transport reservation request entered via the UI may be considered as an indirect transport request that pertains to transportation using the one or more elevators of the elevator transport system 110 at a later time. The user interface device 140 may comprise, for example, a laptop computer or a desktop computer accessible by a plurality of users or the user interface device 140 may comprise a personal (mobile) device such as a mobile phone (e.g. a smartphone), a tablet computer or a laptop computer.

Regardless of the manner of providing the user interface device 140 (e.g. as a computer device available for a number of users or as a personal device of a certain user), access to the transport reservation schedule via the user interface 140 device may require user authentication via a user logging on to his/her user account pertaining to the scheduling system 130 e.g. via entering a username associated with the user account together with a password defined for the user account or using another access control or authentication method known in the art.

The UI of the user interface device 140 may enable a user to place a request for recording a transport reservation for transportation using an elevator of the elevator transport system 110, where the information pertaining to the requested elevator transport received from the user via the UI of the user interface device 140 may be referred to as a transport order. In this regard, the transport order may comprise respective indications of at least the following aspects:
the origin floor,
the reserved transport time period,

The user interface device 140 may, at least conceptually, arrange information that belongs to the transport order into a transport reservation request and transmit the transport reservation request to the scheduling system 130 for recordation therein. Moreover, the user interface device 140 may further include identification of the user in the transport reservation request transmitted to the scheduling system 130 to serve as information that identifies the owner of the respective transport reservation request. Such user-identifying information may comprise the username associated with the user account of the user (obtained e.g. upon the user logging on to the transport reservation schedule) or an(other) user identifier (ID) assigned to the user account.

The transport order may further include an indication of a destination floor, and the user interface device 140 may include this piece of information in the transport reservation request transmitted to the scheduling system 130. In case the elevator transport system 110 comprises two or more elevators, the transport order may further comprise an indication of a requested elevator of the elevator transport system 110, i.e. an indication of the elevator the user wishes to use, and the user interface device 140 may further include an elevator ID assigned to the user-selected elevator in the transport reservation request transmitted to the scheduling system 130 to serve as the indication of the elevator to which the transport reservation pertains.

The UI of the user interface device 140 may enable a user to view transport reservations currently recorded in the transport reservation schedule in the scheduling system 130. In this regard, the currently recorded transport reservations may be displayed via the UI of the user interface device 140 in form of a calendar, which shows the recorded transport reservations at positions that correspond to their respective transport time periods, thereby enabling the user to review the reserved transport time periods and time periods that are available for elevator transport. The UI may enable the user to select a time period covered by such a calendar view to view transport reservations recorded for a time period of interest (e.g. a certain day, a certain week, a certain month, a certain range covering user-selectable dates). The user interface device 140 may be arranged to provide the calendar view showing the transport reservations currently recorded in the transport reservation schedule via usage of a calendar application executing in the user interface device 140 or in the scheduling system 130.

In addition to indicating the respective transport time periods reserved therefor, the calendar view may display additional pieces of information for one or more recorded transport reservations, e.g. one or more of the respective origin floor, the respective destination floor, the owner of the respective transport reservation. In case the transport reservation schedule pertains to more than one elevators, the calendar view may further display the indication of the elevator allocated to serve the respective transport reservation. Alternatively, in case the elevator transport system 110 comprise two or more elevators, the recorded transport reservations for each of the (two or more) elevators may be viewable via respective separate calendar views and the UI may enable the user to choose between such separate calendar views.

In this regard, the user interface device 140 may access the transport reservation schedule in the scheduling system 130 to obtain the relevant pieces of information pertaining to the transport reservations recorded therein, arrange the information obtained from the transport reservation schedule into a format suitable for displaying in the calendar view in the UI and display the processed information via the UI to the user. As an example in this regard, accessing the transport reservation schedule may comprise the user interface device 140 downloading the transport reservations recorded in the transport reservation schedule for a time period of interest from the scheduling system 130 or the user interface device 140 transmitting to the scheduling system 130 a request for obtaining the transport reservations recorded for the time period of interest and the scheduling system 130 responding by transmitting the requested transport reservations to the user interface device 140.

In an example, the UI in the user interface device 140 may enable the user to enter the for recording a transport reservation for transportation using an elevator of the elevator transport system 110 via the calendar view, which may hence serve both to enable viewing the transport reservations currently recorded in the transport reservation schedule and entering a request for recording a new transport reservation. As an example in this regard, the UI may enable the user to select, form the calendar view, an available transport time period of his/her choosing and entering at least the origin floor and the destination to enable the user interface device 140 to compose the information so received into the transport reservation request for transmission to the scheduling system 130. Along the lines described in the foregoing for viewing the currently recorded transport request via the calendar view, the user interface device 140 may be arranged to provide the calendar view for entering the request for recording a new transport reservation via usage of a calendar application available in the user interface device 140 or in the scheduling system 130.

Upon receiving the transport reservation request from the user interface device 140, the transport scheduler 130 consults the transport reservation schedule stored therein to determine whether the received transport reservation request can be accommodated. In this regard, in case the requested transport can be accommodated, the transport scheduler 130 may record the received transport reservation request as a respective transport reservation in the transport reservation schedule and allocate one of the one or more elevators of the elevator transport system 110 to serve the recorded transport reservation. In case the received transport reservation request includes an elevator ID that identifies the elevator to user wished to use (i.e. a requested elevator), the determination with respect to the capability to accommodate the received transport reservation request pertains only to the elevator identified by this elevator ID:
in case the requested elevator is available for transport from the origin floor for the duration of the transport time period indicated in the received transport request, the received transport reservation request is recorded as a transport reservation in the transport reservation schedule and the elevator having the elevator ID included in the received transport reservation request is (at least implicitly) allocated to serve the recorded transport reservation;
in case the requested elevator is not available for transport from the origin floor for the transport time period indicated in the received transport request, the received transport request is refused.

In case the received transport reservation request does not include an elevator ID, the determination with respect to the capability to accommodate the received transport reservation request pertains to all elevators of the elevator transport system 110:
in case any of the one or more elevators of the elevator transport system 110 is available for transport from the origin floor for the duration of the transport time period indicated in the received transport reservation request, the received transport reservation request is recorded as a transport reservation in the transport reservation schedule, one of the available elevators is allocated to serve the recorded transport reservation and the recorded transport reservation is complemented with the elevator ID of this elevator;
in case none of the one or more elevators of the elevator transport system 110 is available for transport from the origin floor for the transport time period indicated in the received transport request, the received transport request is refused.

In case the received transport reservation request includes the destination floor, the above-described determination with respect to accommodation of the requested transport reservation in the transport reservation schedule may further consider the destination floor e.g. such that the availability of elevator transport considers the transport between the origin floor and the destination floor by the identified elevator or by any elevator (as applicable) for the duration of the transport time period indicated in the received transport reservation request.

Upon successful recordation of the transport reservation request as the transport reservation of the transport reservation schedule, the transport scheduler 130 may transmit, to the user interface device 140, a transport request response (e.g. a confirmation) that indicates successfully recorded transport request. The transport scheduler 130 may further allocate and/or assign the activation code and possible also the release code for the newly-recorded transport reservation, store these codes in the transport scheduler 130 (e.g. as part of the respective transport reservation) and include these codes in the transport request response transmitted to the user interface device 140 for subsequent use by the user upon using the elevator allocated to serve the respective transport reservation during the respective reserved transport time period. The activation code and the release code (if applicable) may include a respective sequence of symbols, such as numbers and/or characters, and it may be selected randomly or pseudo-randomly for each recorded transport reservation. In case the transport reservation request is refused by the transport scheduler 130, it may transmit to the user interface device 140 a transport request response that indicates rejection of the transport reservation request (due to unavailability of the requested elevator transport).

In the course of its operation, the elevator controller 120 may automatically prepare the elevator transport system 110 to follow the transport reservations recorded in the transport reservation schedule of the scheduling system 130. In this regard, the elevator controller 120 may obtain the information pertaining to an upcoming transport reservation from the scheduling system 130 (e.g. via the elevator system 120 polling the scheduling system 130 according to a predefined schedule or via the scheduling system 130 informing the elevator system 120 of the upcoming transport reservation). For a given transport request, the elevator control 120 may control the elevator allocated to serve the given transport request (or the sole elevator of the elevator transport system 110) to arrive at the origin floor defined for the respective transport request by the beginning of the reserved transport time period defined for the respective transport request, thereby facilitating guaranteed access to the elevator allocated to serve the respective transport reservation according to the respective transport reservation recorded earlier in the transport reservation schedule. In the following, this elevator may be referred to, in short, as a reserved elevator.

During the reserved transport time period the reserved elevator is available for transport only via a user entering the activation code assigned to the respective transport reservation upon recording the transport reservation in the transport reservation schedule. As non-limiting examples in this regard, the user may enter the activation code via a UI provided in a control panel arranged in the reserved elevator or in a landing served by the reserved elevator or via the UI of the user interface device 140. As an example of the latter, the user may enter the activation code via the UI of his/her personal (mobile) device serving as the user interface device 140, which may transmit the activation code received via the UI to the elevator controller 120 over a wireless connection. As non-limiting examples in this regard, the elevator system 100 may be arranged to enable usage of the activation code during the reserved transport time period in one of the following ways:
The user may enter the activation code together with an indication of the destination floor, which may be considered as a direct transport request. Consequently, upon receiving an activation code that matches the activation code assigned to the respective transport reservation (i.e. a correct activation code) and the direct transport request indicating the destination floor, the elevator controller 120 may control the reserved elevator to move to the destination floor. In contrast, the elevator controller 120 may refuse or ignore a direct transport request that is not provided together with an activation code that matches the activation code assigned to the respective transport reservation (e.g. one provided without an activation code or one provided with an incorrect activation code). This approach enables flexible transfer of passengers and/or cargo between the floors of the user's choosing during the reserved transport time period.
In case the respective transport reservation includes the destination floor, the user may enter an activation code (without a separate indication of the destination floor) and, consequently, the elevator controller 120 may control the reserved elevator to move from the origin floor defined in the respective transport reservation to the destination floor defined in the respective transport reservation or vice versa (depending on the current position of the reserved elevator) upon receiving an activation code that matches the activation code assigned to the respective transport request (i.e. a correct activation code). In contrast, the elevator controller 120 may refuse or ignore an activation code that does not match the activation code assigned to the respective transport reservation (i.e. an incorrect activation code). This approach enables conveniently carrying out multiple runs of transferring passengers and/or cargo between the origin floor and the destination floor.
In case the respective transport reservation includes the destination floor, the user may enter an activation code (without a separate indication of the destination floor) and, consequently, the elevator controller 120 may control the reserved elevator to move from the origin floor defined in the transport reservation to the destination floor defined in the transport reservation upon receiving the correct activation code and, moreover, the elevator controller 120 may control the reserved elevator to automatically return from the destination floor to the origin floor after the reserved elevator has stopped in the destination door, e.g. when the reserved elevator becomes again available for transport (e.g. when the elevator doors have been opened and closed in the destination floor). In contrast, also in this example the elevator controller 120 may refuse or ignore an incorrect activation code. Also this approach enables conveniently carrying out multiple runs of transferring passengers and/or cargo between the origin floor and the destination floor.

The above-described operation relying on the activation code may be continued until the end of the reserved time period indicated in the respective transport reservation, after which the elevator controller 120 may return to its normal operation to serve direct transport requests (without consideration of an activation code) or to serve another transport reservation.

According to an example, the user may terminate an ongoing transport reservation before the end of the reserved time period defined therefor by entering the termination code assigned to the respective reservation upon recording the respective transport reservation in the transport reservation schedule. The user may enter the termination code, for example, via the UI provided in the control panel arranged in the reserved elevator or in a landing served by the reserved elevator or via using his/her personal (mobile) device (as described in the foregoing for entering the activation code). The elevator controller 120 may respond to receiving the (correct) termination code (entered by the user) by immediately terminating the currently ongoing transport reservation and releasing the reserved elevator to its normal operation during which the elevator controller 120 may serve direct transport requests (without consideration of an activation code).

In the examples above, the elevator controller 120 may verify validity of the activation code and/or the termination code via consulting the scheduling system 130. In this regard, the elevator controller 120 may receive the respective activation code and/or the termination code from the scheduling system 130 and carry out the verification of the user-entered code against the respective code obtained from the scheduling system 130 or the elevator controller 120 may forward the activation code and/or the termination code to the scheduling system 130, which may carry out the verification and return the outcome of the verification (successful/unsuccessful) to the elevator controller 120.

Referring back to providing the elevator system 100 as a construction-time elevator system that will be subsequently converted into an elevator system of a completed building, the elevator transport system 110 and/or the elevator controller 120 as applied in the course of operation of the elevator system 100 according to the present disclosure may be likewise one under construction such that they are available for use as a construction-time elevator system in the building under construction while at least one of them needs to be subsequently modified or complemented to serve as a respective element of the elevator system of the completed building. Non-limiting examples in this regard include the following:
The elevator transport system 110 and/or the elevator controller 120 may be at least partially incomplete via lacking one or more elevator components required in an elevator system of a completed building and, consequently, the elevator system 110 and/or the elevator controller 120 may need to be complemented with the one or more elevator components in order to serve as the elevator system of the completed building that is suitable for normal passenger use. As examples in this regard, the lacking elevator components may comprise one or more functional or structural components of an elevator car, an elevator shaft and/or elevator controller 120.
The elevator transport system 110 and/or the elevator controller 120 may be partially incomplete via including one or more elevator components that are not applicable for use as components of an elevator system of a completed building and they need be replaced with other components in order to fulfill requirements of an elevator system of a completed building that is suitable for normal passenger use and, consequently, the elevator system 110 needs to be modified by replacing these one or more elevator components with requirement-fulfilling ones in order to serve as the elevator system of the completed building. As examples in this regard, the elevator components that require replacement may comprise one or more functional or structural components of an elevator car, an elevator shaft and/or elevator controller 120.
The elevator transport system 110 as applied in the building under-construction may comprise one or more vertically-extendable elevators that in the course of construction work are extended to serve an increasing number of floors as the construction work proceeds to an increasing number of floors. In other words, in the course of operation of the elevator system 100 in the building under construction, a vertically-extendable elevator may serve a first number floors at a first point of time and serve a second number of floors at a later point of time, where the second number is larger than the first number. Such elevator systems are known in the art and described, for example, in respective patent publications EP 3763635 A1 and WO 2020/245373 A1.

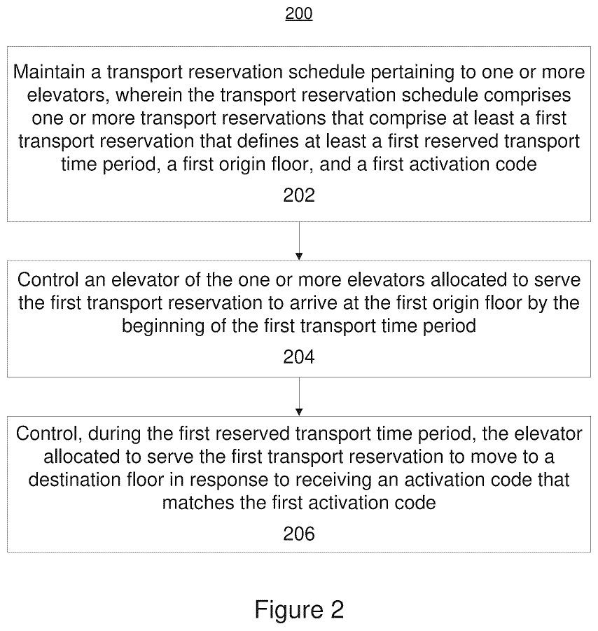

The operation described in the foregoing with references to elements of the elevator control system 150, e.g. the elevator controller 120 and/or the scheduling system 130 may be, alternatively, described as steps of a method. As an example in this regard, FIG. 2 depicts a flowchart illustrating a method 200 for controlling movement of the one or more elevators of an elevator transport system 110 between the one or more floors of a building under construction, which method may be carried out by one or more elements of the elevator control system 150. Respective operations described with references to blocks 202 to 206 pertaining to the method 200 may be implemented, varied and/or complemented in a number of ways, for example as described with references to elements of the elevator control system 150 in the foregoing and/or in the following.

The method 200 comprises maintaining the transport reservation schedule pertaining to the one or more elevators, wherein the transport reservation schedule comprises one or more transport reservations that comprise at least a first transport reservation that defines at least a first reserved transport time period, a first origin floor, and a first activation code, as indicated in block 202. In this regard, the transport reservation schedule may comprise one or more further transport reservations, e.g. a second transport reservation that defines at least a second reserved transport time period, a second origin floor and a second activation code, a third transport reservation that defines at least a third reserved transport time period, a third origin floor and a third activation code, and so on.

The method 200 further comprises controlling an elevator allocated to serve the first transport reservation to arrive at the first origin floor by the beginning of the first transport time period, as indicated block 204, and controlling, during the first reserved transport time period, the elevator allocated to serve the first transport reservation to move to a destination floor in response to receiving an activation code that matches the first activation code, as indicated in block 206. In a further example, the method 200 may further comprise controlling said elevator allocated to serve the first transport reservation to automatically return to the first origin floor after having stopped at said destination floor. In another example, the method 200 may further comprise carrying out one of the following in response to reception of an activation code that matches the first activation code (depending on the current position of the elevator): controlling said elevator allocated to serve the first transport reservation to move from the first origin floor to said destination floor, or controlling said elevator allocated to serve the first transport reservation to move from said destination floor to the first origin floor.

FIG. 3 illustrates a block diagram of some components of an apparatus 300 that may be employed to implement operations described in the foregoing with references to elements of the elevator control system 150, e.g. the elevator controller 120 and/or the scheduling system 130. The apparatus 300 comprises a processor 310 and a memory 320. The memory 320 may store data and computer program code 325. The apparatus 300 may further comprise communication means 330 for wired or wireless communication with other apparatuses and/or user I/O (input/output) components 340 that may be arranged, together with the processor 310 and a portion of the computer program code 325, to provide the user interface for receiving input from a user and/or providing output to the user. In particular, the user I/O components may include user input means, such as one or more keys or buttons, a keyboard, a touchscreen or a touchpad, etc. The user I/O components may include output means, such as a display or a touchscreen. The components of the apparatus 300 are communicatively coupled to each other via a bus 350 that enables transfer of data and control information between the components.

The memory 320 and a portion of the computer program code 325 stored therein may be further arranged, with the processor 310, to cause the apparatus 300 to perform at least some aspects of operation of the elevator control system 150 described in the foregoing. The processor 310 is configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some or all of which may be integrated/removable and/or may provide permanent/semi-permanent/dynamic/cached storage.

The computer program code 325 may comprise computer-executable instructions that implement at least some aspects of operation of the elevator control system 150 described in the foregoing when loaded into the processor 310. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus 300 to perform at least some aspects of operation of the elevator control system 150 described in the foregoing. Hence, the apparatus 300 may comprise at least one processor 310 and at least one memory 320 including the computer program code 325 for one or more programs, the at least one memory 320 and the computer program code 325 configured to, with the at least one processor 310, cause the apparatus 300 to perform at least some aspects of operation of the elevator control system 150 described in the foregoing.

The computer program code 325 may be provided e.g. a computer program product comprising at least one computer-readable non-transitory medium having the computer program code 325 stored thereon, which computer program code 325, when executed by the processor 310 causes the apparatus 300 to perform at least some aspects of operation of the elevator control system 150 described in the foregoing. The computer-readable non-transitory medium may comprise a memory device or a record medium such as a CD-ROM, a DVD, a Blu-ray disc or another article of manufacture that tangibly embodies the computer program. As another example, the computer program may be provided as a signal configured to reliably transfer the computer program.

Reference(s) to a processor herein should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described.

1. An elevator control system comprising:
an elevator controller for controlling movement of one or more elevators of an elevator transport system between one or more floors of a building under construction; and
a scheduling system for maintaining a transport reservation schedule pertaining to said one or more elevators, wherein the transport reservation schedule comprises one or more transport reservations that comprise at least a first transport reservation that defines at least a first reserved transport time period, a first origin floor, and a first activation code,
wherein the elevator controller is arranged to:
control an elevator allocated to serve the first transport reservation to arrive at the first origin floor by the beginning of the first transport time period, and
control, during the first reserved transport time period, said elevator allocated to serve the first transport reservation to move to a destination floor in response to receiving an activation code that matches the first activation code.

2. An elevator control system according to claim 1, wherein the first transport reservation further defines said elevator allocated to serve the first transport reservation.

3. An elevator control system according to claim 1, wherein the controller is arranged to control said elevator allocated to serve the first transport reservation to automatically return to the first origin floor after having stopped at said destination floor.

4. An elevator control system according to claim 1, wherein said first transport reservation further defines said destination floor and wherein the elevator controller is arranged to carry out one of the following in response to receiving an activation code that matches the first activation code:
control said elevator allocated to serve the first transport reservation to move from the first origin floor to said destination floor,
control said elevator allocated to serve the first transport reservation to move from said destination floor to the first origin floor.

5. An elevator control system according to claim 1, wherein the elevator controller is arranged to receive said activation code from a user interface device that is communicatively coupled to the elevator controller.

6. An elevator control system according to claim 1, wherein the elevator controller is arranged to receive said activation code from a control panel arranged in one of the following: said elevator allocated to serve the first transport reservation, a landing served by said elevator allocated to serve the first transport reservation.

7. An elevator control system according to claim 1, wherein the elevator controller is arranged to ignore transport requests pertaining to said elevator allocated to serve the first transport reservation that are received during the first reserved transport time period without an activation code that matches the first activation code.

8. An elevator control system according to claim 1, wherein said first transport reservation further defines a first termination code and wherein the elevator controller is arranged to terminate the first reserved transport time period in response to receiving a termination code that matches the first termination code.

9. An elevator control system according to claim 1, wherein the scheduling system is arranged to record said one or more transport reservations based on respective transport requests received from one or more user interface devices.

10. An elevator control system according to claim 9, wherein the scheduling system is arranged to
receive a first transport reservation request from a user interface device, wherein the first transport reservation request defines at least the first reserved transport time period and the first origin floor; and
carry out the following in case the scheduling system is able to accommodate the first transport reservation request:
record said first transport reservation request as the first transport reservation,
allocate one of said one or more elevators to serve the first transport reservation, and
assign the first activation code to the first transport reservation and complement the recorded first transport reservation with the first activation code.

11. An elevator control system according to claim 1, further comprising a user interface device for placing a transport reservation request, the user interface device arranged to:
receive, via a user interface, UI, a transport order including at least respective indications of a requested origin floor and a requested reserved transport time;
arrange the transport order into the transport reservation request; and
transmit the transport reservation request to the scheduling system for recordation in the transport reservation schedule therein.

12. An elevator control system according to claim 11, wherein the transport order further comprises respective indications of at least one of the following: a destination floor, a requested elevator of the elevator transport system.

13. An elevator control system according to claim 11, arranged to receive the transport order via a calendar view displayed via the UI of the user interface device.

14. An elevator system comprising an elevator control system according to claim 1 and the elevator transport system including said one or more elevators.

15. An elevator system according to claim 14, wherein the elevator system comprises a construction-time elevator system that is at least partially incomplete in terms of usage as an elevator system of a completed building.

16. An elevator system according to claim 15, wherein at least one of the following applies:
the elevator transport system and/or the elevator controller lack one or more elevator components required in an elevator system of a completed building;
the elevator transport system and/or the elevator controller include one or more elevator components that are not applicable for use as components of an elevator system of a completed building.

17. An elevator system according to claim 15, wherein the elevator transport system comprises at least one vertically-extendable elevator that is extendable to serve an increasing number of floors as the number of floors in the building under construction increases with progress of construction work.

18. An elevator system according to claim 17, wherein the at least one vertically-extendable elevator is arranged to serve a first number of floors at a first point of time and to serve a second number of floors at a later point of time, where the second number is larger than the first number.

19. A method for controlling movement of one or more elevators of an elevator transport system between one or more floors of a building under construction, the method comprising:
maintaining a transport reservation schedule pertaining to said one or more elevators, wherein the transport reservation schedule comprises one or more transport reservations that comprise at least a first transport request that defines at least a first reserved transport time period, a first origin floor, and a first activation code;
controlling an elevator allocated to serve the first transport reservation to arrive at the first origin floor by the beginning of the first transport time period; and
controlling, during the first reserved transport time period, said elevator allocated to serve the first transport reservation to move to a destination floor in response to receiving an activation code that matches the first activation code.

20. A method according to claim 19, further comprising:
controlling said elevator allocated to serve the first transport reservation to automatically return to the first origin floor after having stopped at said destination floor.

21. A method according to claim 19, wherein said first transport reservation further defines said destination floor, the method further comprising carrying out one of the following in response to reception of an activation code that matches the first activation code:
controlling said elevator allocated to serve the first transport reservation to move from the first origin floor to said destination floor,
controlling said elevator allocated to serve the first transport reservation to move from said destination floor to the first origin floor.

22. A computer program comprising computer readable program code configured to cause performing of the method according to claim 19 when said program code is run on a computer apparatus.
